(19) United States
(12) Patent Application Publication
(10) Pub. No.: US 2015/0347927 A1
(43) Pub. Date: Dec. 3, 2015

(54) CANONICAL CO-CLUSTERING ANALYSIS

(71) Applicant: NEC Laboratories America, Inc., Princeton, NJ (US)

(72) Inventors: Kai Zhang, Princeton, NJ (US); Guofei Jiang, Princeton, NJ (US)

(21) Appl. No.: 14/717,555

(22) Filed: May 20, 2015

Related U.S. Application Data
(60) Provisional application No. 62/007,091, filed on Jun. 3, 2014.

(51) Int. Cl. G06N 99/00; G06F 17/16; G06F 17/30

(52) U.S. Cl. CPC G06N 99/005; G06F 17/30958; G06F 17/16

(57) ABSTRACT

A method and system are provided. The method includes determining from a data matrix having rows and columns, a clustering vector of the rows and a clustering vector of the columns. Each row in the clustering vector of the rows is a row instance and each row in the clustering vector of the columns is a column instance. The method further includes performing correlation of the row and column instances. The method also includes building a normalizing graph using a graph-based manifold regularization that enforces a smooth target function which, in turn, assigns a value on each node of the normalizing graph to obtain a Lapacian matrix. The method additionally includes performing Eigenvalue decomposition on the Lapacian matrix to obtain Eigenvectors. The method further includes providing a canonical co-clustering analysis function by maximizing a coupling between clustering vectors while concurrently enforcing regularization on each clustering vector using the Eigenvectors.

### RELATED APPLICATION INFORMATION

This application claims priority to provisional application Ser. No. 62/007,091 filed on Jun. 3, 2014, incorporated herein by reference.

### BACKGROUND

1. Technical Field

The present invention relates to information analysis, and more particularly to canonical co-clustering analysis.

2. Description of the Related Art

The co-clustering or bi-clustering problem refers to simultaneously clustering the rows and columns of a data matrix. However, prior art methods for solving the co-clustering problem suffer from a high cost of hyper-parameter tuning, a lack of fine-grained adjustability of the co-clustering result, an inability to handle negative data entries, as well as other deficiencies.

### SUMMARY

These and other drawbacks and disadvantages of the prior art are addressed by the present principles, which are directed to canonical co-clustering analysis.

According to an aspect of the present principles, a method is provided. The method includes determining, by a clustering vector generator, from a data matrix having rows and columns, a clustering vector of the rows in the data matrix and a clustering vector of the columns in the data matrix. Each row in the clustering vector of the rows is a row instance and each row in the clustering vector of the columns is a column instance. The method further includes performing, by an instance correlator, correlation of the row and column instances. The method also includes building, by a normalizing graph builder, a normalizing graph using a graph-based manifold regularization that enforces a smooth target function which, in turn, assigns a value on each node of the normalizing graph to obtain a Lapacian matrix. The method additionally includes performing, by an Eigenvalue decomposer, Eigenvalue decomposition on the Lapacian matrix to obtain Eigenvectors therefrom. The method further includes providing, by a canonical co-clustering analysis function generator, a canonical co-clustering analysis function by maximizing a coupling between the clustering vectors while concurrently enforcing regularization on each of the clustering vectors using the Eigenvectors.

According to another aspect of the present principles, a system is provided. The system includes a clustering vector generator for determining, from a data matrix having rows and columns, a clustering vector of the rows in the data matrix and a clustering vector of the columns in the data matrix. Each row in the clustering vector of the rows is a row instance and each row in the clustering vector of the columns is a column instance. The system further includes an instance correlator for performing correlation of the row and column instances. The system also includes a normalizing graph builder for building a normalizing graph using a graph-based manifold regularization that enforces a smooth target function which, in turn, assigns a value on each node of the normalizing graph to obtain a Lapacian matrix. The system additionally includes an Eigenvalue decomposer for performing Eigenvalue decomposition on the Lapacian matrix to obtain Eigenvectors therefrom. The system further includes a canonical co-clustering analysis function generator for providing a canonical co-clustering analysis function by maximizing a coupling between the clustering vectors while concurrently enforcing regularization on each of the clustering vectors using the Eigenvectors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary system 200 for canonical co-clustering analysis, in accordance with an embodiment of the present principles; and

FIG. 3 shows an exemplary method 300 for canonical co-clustering analysis, in accordance with an embodiment of the present principles.

### DETAILED DESCRIPTION OF PREFERRED EMBODIMENTS

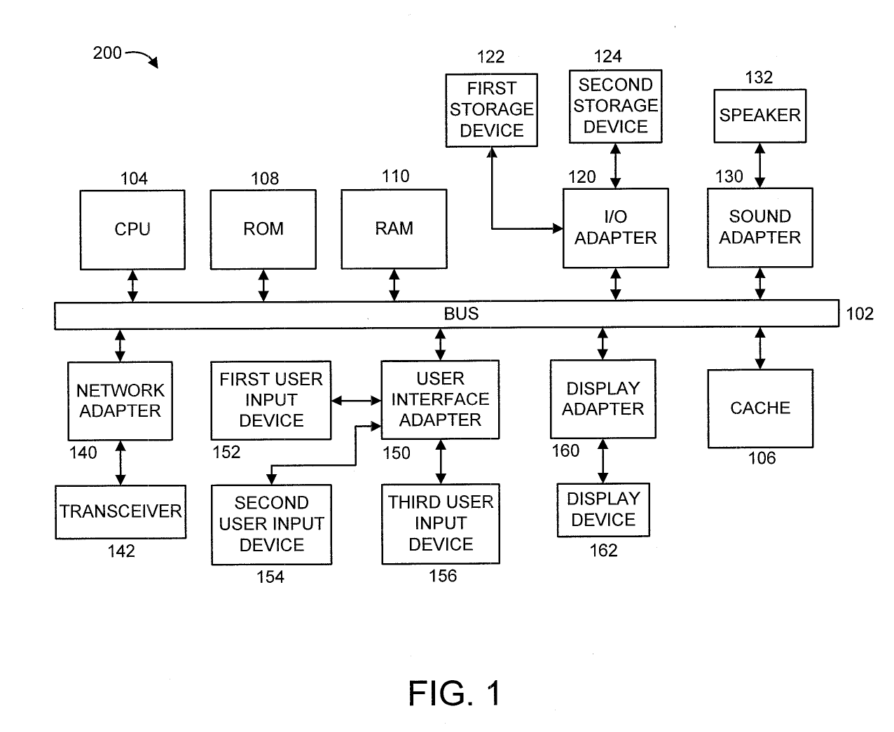

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

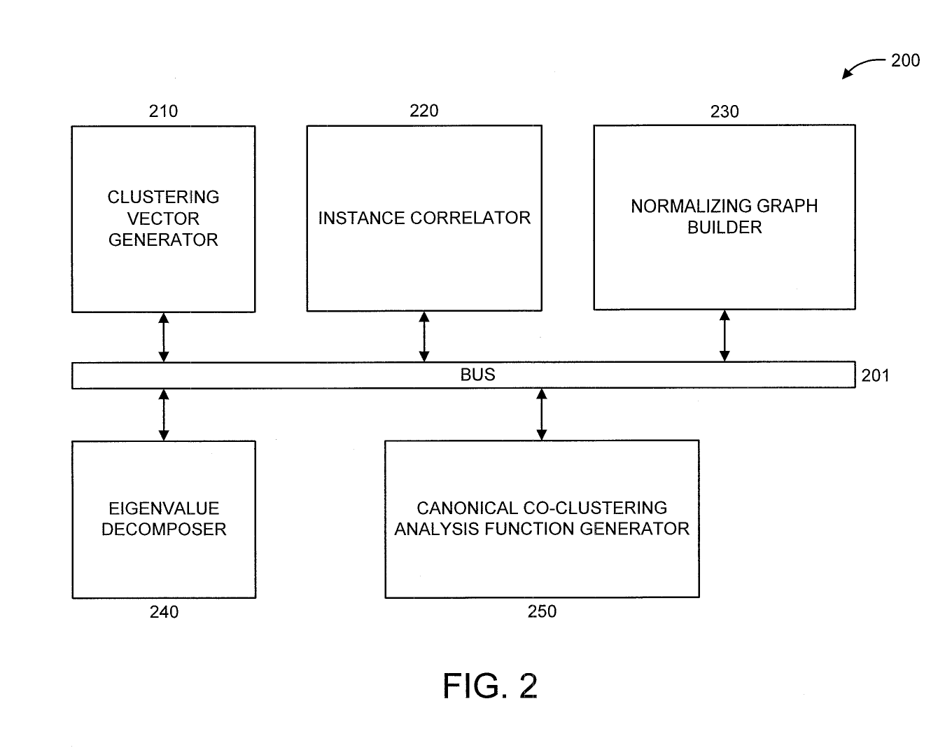

Moreover, it is to be appreciated that system 200 described below with respect to FIG. 2 is a system for implementing respective embodiments of the present principles. Part or all of processing system 100 may be implemented in one or more of the elements of system 200.

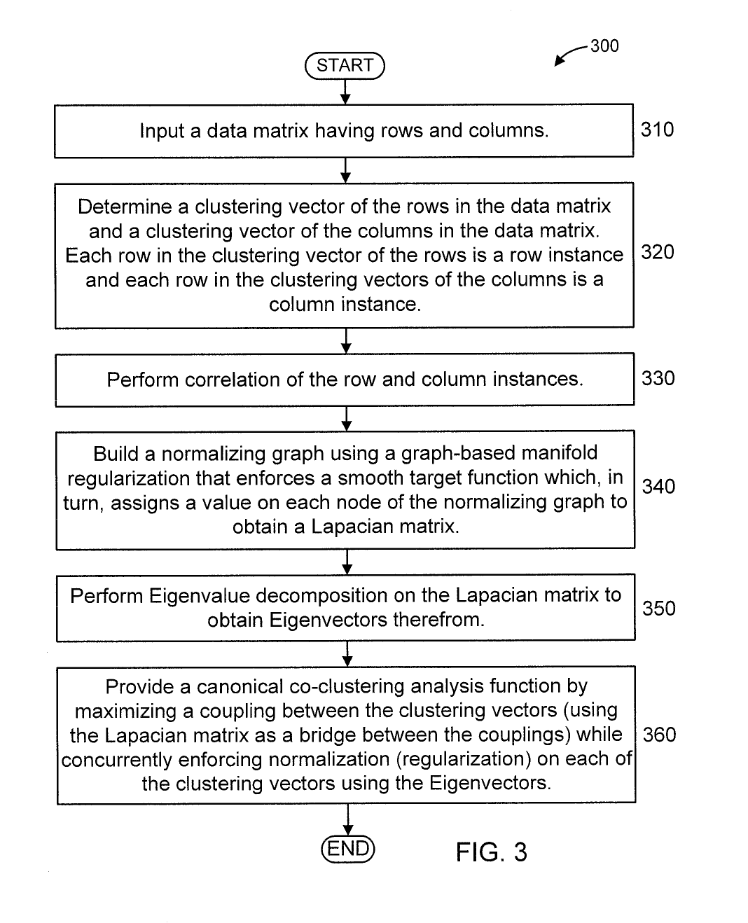

Further, it is to be appreciated that processing system 100 may perform at least part of the method described herein including, for example, at least part of method 300 of FIG. 3. Similarly, part or all of system 200 may be used to perform at least part of method 300 of FIG. 3.

FIG. 2 shows an exemplary system 200 for canonical co-clustering analysis, in accordance with an embodiment of the present principles.

The system 200 includes a clustering vector generator 210, an instance correlator 220, a normalizing graph builder 230, an Eigenvalue decomposer 240, and canonical co-clustering analysis function generator 250.

The clustering vector generator 210 inputs a data matrix having rows and columns, and generates/determines a clustering vector of the rows in the data matrix and a clustering vector of the columns in the data matrix. Each row in the clustering vector of the rows is a row instance and each row in the clustering vectors of the columns is a column instance.

The instance correlator 220 performs correlation of the row and column instances.

The normalizing graph builder 230 builds a normalizing graph using a graph-based manifold regularization that enforces a smooth target function which, in turn, assigns a value on each node of the normalizing graph to obtain a Lapacian matrix.

The Eigenvalue decomposer 240 performs Eigenvalue decomposition on the Lapacian matrix to obtain Eigenvectors therefrom.

The canonical co-clustering analysis function generator 250 provides a canonical co-clustering analysis function by maximizing a coupling between the clustering vectors while concurrently enforcing regularization on each of the clustering vectors using the Eigenvectors.

In the embodiment shown in FIG. 2, the elements thereof are interconnected by a bus 201. However, in other embodiments, other types of connections can also be used. Moreover, in an embodiment, at least one of the elements of system 200 is processor-based. Further, while one or more elements may be shown as separate elements, in other embodiments, these elements can be combined as one element. These and other variations of the elements of system 200 are readily determined by one of ordinary skill in the art, given the teachings of the present principles provided herein, while maintaining the spirit of the present principles.

FIG. 3 shows an exemplary method 300 for canonical co-clustering analysis, in accordance with an embodiment of the present principles.

At step 310, input a data matrix having rows and columns. In an embodiment, the rows and columns are of different dimensions.

At step 320, determine a clustering vector of the rows in the data matrix and a clustering vector of the columns in the data matrix. Each row in the clustering vector of the rows is a row instance and each row in the clustering vectors of the columns is a column instance. In an embodiment, the vectors are of a different dimension than the dimensions of the rows and the columns of the data matrix.

At step 330, perform correlation of the row and column instances. In an embodiment, step 340 involves performing cross-correlation of the row and column instances.

At step 340, build a normalizing graph using a graph-based manifold regularization that enforces a smooth target function which, in turn, assigns a value on each node of the normalizing graph to obtain a Lapacian matrix. By smooth target function, we mean that if two nodes are closely connected with each other on the graph (i.e., the edge between these two nodes has a large weight), then the target function values on these two nodes will also be close to each other.

At step 350, perform Eigenvalue decomposition on the Lapacian matrix to obtain Eigenvectors therefrom.

At step 360, provide a canonical co-clustering analysis function by maximizing a coupling between the clustering vectors (using the Lapacian matrix as a bridge between the couplings) while concurrently enforcing normalization (regularization) on each of the clustering vectors using the Eigenvectors.

In accordance with the present principles, a new framework is proposed which is referred to herein as canonical correlation co-clustering (CCCA). Advantageously, CCCA solves the aforementioned co-clustering problem. In an embodiment, the present principles maximize the correlation between the row- and column clustering, while at the same time the alignment is subject to a divisive normalization that penalizes the non-smooth clustering over the row and column clustering. The normalization terms are based on the sub-blocks of the graph Lapacian of the so-called normalizing graph. By choosing different types of normalizing graphs, we can achieve co-clustering of different “flavors”, subsuming the spectral co-clustering as one of its special cases.

In an embodiment, the canonical co-clustering analysis can be used to perform patient clustering to determine a next course of action and/or specifics for a course of action for a given cluster of patients or a specific patient in a cluster. For example, based on a result of the canonical co-clustering analysis, a machine can be controlled such as, but limited to a radiation emitting machine. In such a case, as an example, the amount of radiation emitted by the machine can be controlled responsive to a result of the canonical co-clustering analysis. Other applications include, but are not limited to, text mining and computer vision problems. These and other exemplary applications to which the present principles can be applied are readily determined by one of ordinary skill in the art given the teachings of the present principles provided herein, while maintaining the spirit of the present principles.

A description will now be given of some of the many attendant advantages of the present principles.

For example, no prior art exists that advantageously applies the correlation analysis and a divisive Lapacian normalization term together to obtain co-clustering results. In accordance with an embodiment of the present principles, we innovatively combine the correlation analysis with manifold regularization using the graph Lapacian, which avoids the tuning of regularization parameters, and allows the handling of negative entries in the data.

Moreover, in accordance with an embodiment of the present principles, the canonical correlation analysis and Lapacian-based manifold regularization are seamlessly combined together in an optimization framework, so as to achieve co-clustering that is both maximally correlated and at the same time smooth with regard to the row and column manifold.

Further advantages include, but are not limited to, the following:

(1) existing approaches to spectral co-clustering cannot handle a data matrix with negative entries, while the present principles readily can handle a data matrix with negative entries;
(2) the present principles can have better clustering accuracies than the prior art;
(3) the present principles can automatically determine the graph structures and avoid choosing the regularization parameters which are needed in prior art manifold co-clustering methods.

These and other advantages of the present principles are readily determined by one of ordinary skill in the art given the teachings of the present principles provided herein, while maintaining the spirit of the present principles.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method, comprising:
determining, by a clustering vector generator, from a data matrix having rows and columns, a clustering vector of the rows in the data matrix and a clustering vector of the columns in the data matrix, wherein each row in the clustering vector of the rows is a row instance and each row in the clustering vector of the columns is a column instance;
performing, by an instance correlator, correlation of the row and column instances;
building, by a normalizing graph builder, a normalizing graph using a graph-based manifold regularization that enforces a smooth target function which, in turn, assigns a value on each node of the normalizing graph to obtain a Lapacian matrix;
performing, by an Eigenvalue decomposer, Eigenvalue decomposition on the Lapacian matrix to obtain Eigenvectors therefrom; and
providing, by a canonical co-clustering analysis function generator, a canonical co-clustering analysis function by maximizing a coupling between the clustering vectors while concurrently enforcing regularization on each of the clustering vectors using the Eigenvectors.

2. The method of claim 1, wherein the dimensions of the rows and the columns of the data matrix are different, and a dimension of the clustering vectors is different from the dimensions of the rows and the columns of the data matrix.

3. The method of claim 1, wherein the normalizing graph is built as a Bipartite graph.

4. The method of claim 3, wherein the canonical co-clustering analysis function is configured as a spectral canonical co-clustering analysis function.

5. The method of claim 1, wherein the normalizing graph is built as a two-component graph having two disconnected components corresponding to two sub-graphs associated with the rows and the columns of the data matrix.

6. The method of claim 5, wherein edge weights of intra-view edges in the two-component graph are determined based on at least one of row similarities and column similarities in at least one similarity matrix determined from the data matrix.

7. The method of claim 5, wherein the edge weights are determined using a similarity function that uses nearest neighbors or a Gaussian function.

8. The method of claim 1, wherein the normalizing graph is built using sub-space clustering.

9. The method of claim 1, wherein the normalizing graph is built to include one or more grouping constraints.

10. The method of claim 1, wherein the normalizing graph is built to include partially labeled samples of the rows and the columns in the data matrix.

11. The method of claim 1, wherein the normalizing graph is built to enforce specific requirements on the canonical co-clustering analysis.

12. A non-transitory article of manufacture tangibly embodying a computer readable program which when executed causes a computer to perform the steps of claim 1.

13. A system, comprising:
a clustering vector generator for determining, from a data matrix having rows and columns, a clustering vector of the rows in the data matrix and a clustering vector of the columns in the data matrix, wherein each row in the clustering vector of the rows is a row instance and each row in the clustering vector of the columns is a column instance;
an instance correlator for performing correlation of the row and column instances;
a normalizing graph builder for building a normalizing graph using a graph-based manifold regularization that enforces a smooth target function which, in turn, assigns a value on each node of the normalizing graph to obtain a Lapacian matrix;
an Eigenvalue decomposer for performing Eigenvalue decomposition on the Lapacian matrix to obtain Eigenvectors therefrom; and
a canonical co-clustering analysis function generator for providing a canonical co-clustering analysis function by maximizing a coupling between the clustering vectors while concurrently enforcing regularization on each of the clustering vectors using the Eigenvectors.

14. The system of claim 13, wherein the normalizing graph is built as a Bipartite graph.

15. The system of claim 13, wherein the normalizing graph is built as a two-component graph having two disconnected components corresponding to two sub-graphs associated with the rows and the columns of the data matrix.

16. The system of claim 15, wherein edge weights of intra-view edges in the two-component graph are determined based on at least one of row similarities and column similarities in at least one similarity matrix determined from the data matrix.

17. The system of claim 13, wherein the normalizing graph is built using sub-space clustering.

18. The system of claim 13, wherein the normalizing graph is built to include one or more grouping constraints.

19. The system of claim 13, wherein the normalizing graph is built to include partially labeled samples of the rows and the columns in the data matrix.

20. The system of claim 13, wherein the normalizing graph is built to enforce specific requirements on the canonical co-clustering analysis.
